(19) United States
(12) Patent Application Publication
(10) Pub. No.: US 2024/0202497 A1
(43) Pub. Date: Jun. 20, 2024

(54) METHOD AND APPARATUS FOR COMPUTER VISION PROCESSING

(71) Applicants: ROBERT BOSCH GMBH, Stuttgant (DE); TSINGHUA UNIVERSITY, Beijing (CN)

(72) Inventors: Chunjiang Ge, Beijing (CN); Gao Huang, Beijing (CN); Rui Lu, Beijing (CN); Shiji Song, Beijing (CN); Xuran Pan, Beijing (CN); Hao Yang, Beijing (CN)

(21) Appl. No.: 18/572,377

(22) PCT Filed: Jul. 21, 2021
(86) PCT No.: PCT/CN2021/107598

§ 371 Date: Dec. 20, 2023

(51) Int. Cl. G06N 3/045; G06N 3/0464

(52) U.S. Cl. CPC G06N 3/045; G06N 3/0464

(57) ABSTRACT

A method for computer vision processing. The method includes projecting input visual data into a plurality of intermediate feature maps by performing a plurality of 1×1 convolution operations; generating an attention weighted map by performing attention and aggregation operations on the plurality of intermediate feature maps; generating a convolved feature map by performing shift and summation operations on the plurality of intermediate feature maps; and adding the attention weighted map and the convolved feature map based on at least one scalar.

### FIELD

The present invention relates generally to artificial intelligence technology, and more particularly, to computer vision processing techniques.

### BACKGROUND

Computer vision is a field of artificial intelligence (AI) that enables computers and systems to derive meaningful information from digital images, videos and other visual inputs and take actions or make recommendations based on that information. Examples of a computer vision task may include image recognition, semantic segmentation and object detection.

In recent years, convolution technique and self-attention technique are rapidly developing in the computer vision field. Convolution neural networks (CNNs) are widely adopted on image recognition, semantic segmentation and object detection, and achieve state-of-the-art performances on many benchmark datasets. Self-attention is first introduced in natural language processing (NLP) models, and also shows great potential in the fields of image generation and super-resolution. With the advent of vision transformers, attention-based modules have achieved comparable or even better performance than their CNN counterparts on many vision tasks.

Despite the great success the both techniques have achieved, the convolution and self-attention module usually follow different design paradigms. Traditional convolution layer is an aggregation function over a localized receptive field according to the convolution filter weights, which are shared in the whole image or feature map. The intrinsic characteristics impose crucial inductive biases for image processing. Comparably, the self-attention module applies a weighted average operation based on the context of an image or feature maps, where the attention weights are computed dynamically via a similarity function between related pixel pairs. The flexibility enables the attention module to focus on different regions adaptively and capture better features.

Considering the different and complementary properties of convolution and self-attention, there exists a need of integrating these modules to benefit from both paradigms.

### SUMMARY

The following presents a simplified summary of one or more aspects according to the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the present invention, a method for computer vision processing is disclosed. The method may comprise projecting input visual data into a plurality of intermediate feature maps by performing a plurality of 1×1 convolution operations; generating an attention weighted map by performing attention and aggregation operations on the plurality of intermediate feature maps; generating a convolved feature map by performing shift and summation operations on the plurality of intermediate feature maps; and adding the attention weighted map and the convolved feature map based on at least one scalar.

In another aspect of the present invention, an apparatus for computer vision processing is disclosed. The apparatus may comprise a 1×1 convolution module configured to project input visual data into a plurality of intermediate feature maps by performing a plurality of 1×1 convolution operations; an attention and aggregation module configured to generate an attention weighted map by performing attention and aggregation operations on the plurality of intermediate feature maps; a shift and summation module configured to generate a convolved feature map by performing shift and summation operations on the plurality of intermediate feature maps; and an addition module configured to add the attention weighted map and the convolved feature map based on at least one scalar.

In another aspect of the present invention, an apparatus for computer vision processing is disclosed. The apparatus may comprise a memory and at least one processor coupled to the memory. The at least one processor may be configured to project input visual data into a plurality of intermediate feature maps by performing a plurality of 1×1 convolution operations; generate an attention weighted map by performing attention and aggregation operations on the plurality of intermediate feature maps; generate a convolved feature map by performing shift and summation operations on the plurality of intermediate feature maps; and add the attention weighted map and the convolved feature map based on at least one scalar.

In another aspect of the present invention, a computer readable medium storing computer code for computer vision processing is disclosed. The computer code, when executed by a processor, may cause the processor to project input visual data into a plurality of intermediate feature maps by performing a plurality of 1×1 convolution operations; generate an attention weighted map by performing attention and aggregation operations on the plurality of intermediate feature maps; generate a convolved feature map by performing shift and summation operations on the plurality of intermediate feature maps; and add the attention weighted map and the convolved feature map based on at least one scalar.

In another aspect of the present invention, a computer program product for computer vision processing is disclosed. The computer program product may comprise processor executable computer code for projecting input visual data into a plurality of intermediate feature maps by performing a plurality of 1×1 convolution operations; generating an attention weighted map by performing attention and aggregation operations on the plurality of intermediate feature maps; generating a convolved feature map by performing shift and summation operations on the plurality of intermediate feature maps; and adding the attention weighted map and the convolved feature map based on at least one scalar.

Other aspects or variations of the present invention will become apparent by consideration of the following detailed description and the figures.

### BRIEF DESCRIPTION OF THE DRAWINGS

The following figures depict various embodiments of the present invention for purposes of illustration only. One skilled in the art will readily recognize from the following description that alternative embodiments of the methods and structures disclosed herein may be implemented without departing from the spirit and principles of the disclosure herein.

FIG. 1 illustrates an example of traditional convolution operation in accordance with one aspect of the present invention.

FIG. 2 illustrates an example of a two stage convolution operation in accordance with one aspect of the present invention.

FIG. 3 illustrates an example of a two stage self-attention operation in accordance with one aspect of the present invention.

FIG. 4 illustrates a block diagram of an apparatus for computer vision processing in accordance with one aspect of the present invention.

FIG. 5 illustrates an example of a hybrid model of self-attention and convolution in accordance with one aspect of the present invention.

FIG. 6 illustrates a flow chart of a method for computer vision processing in accordance with one aspect of the present invention.

FIG. 7 illustrates a block diagram of an apparatus for computer vision processing in accordance with one aspect of the present invention.

### DETAILED DESCRIPTION OF EXAMPLE EMBODIMENTS

Before any embodiments of the present invention are explained in detail, it is to be understood that the present invention is not limited in its application to the details of construction and the arrangement of features set forth in the following description. The present invention is capable of other embodiments and of being practiced or of being carried out in various ways.

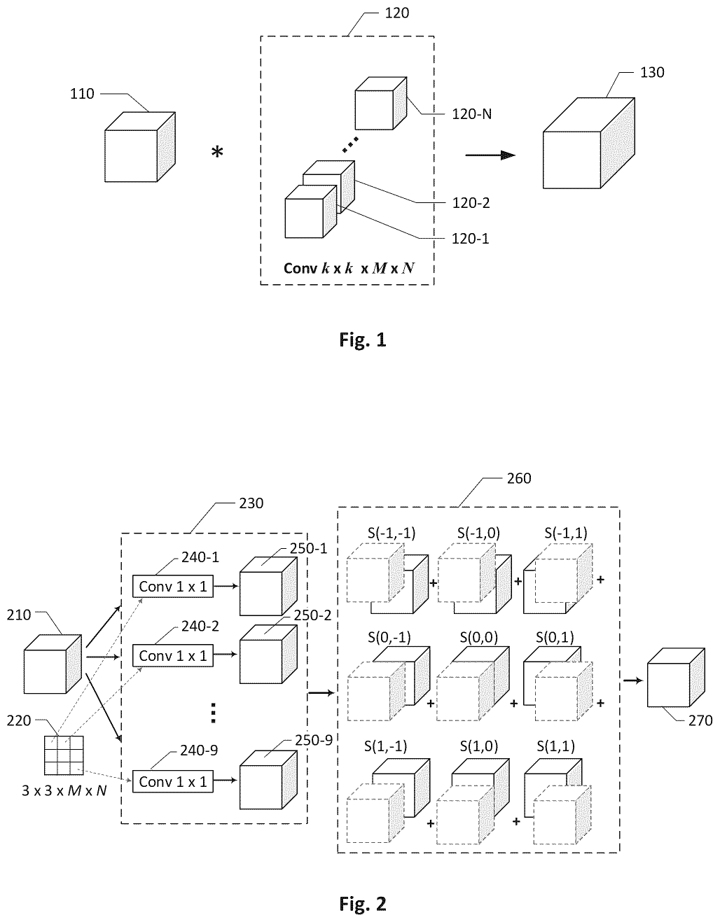

A convolutional network using convolutional kernels to extract local features has become a very powerful and conventional technique for various computer vision tasks. The convolution operation is one of the most essential parts in the modern convolution networks. FIG. 1 illustrates an example of traditional convolution operation in accordance with an aspect of the present disclosure. As illustrated by block 120 in FIG. 1, a convolution kernel K∈R^{k×k×M×N} is used in a standard convolution operation, where k is the kernel size of the convolution, M equals to the input channel size, and N equals to the output channel size.

Block 110 may be input visual data for following computer vision processing. The visual data may be obtained from optical sensors, radar sensors, ultrasonic sensors, nuclear magnetic resonance sensors, etc., including original image data generated by one or more of these sensors, visualized image data generated after certain visualization processing on the original data from one or more of these sensors, or a feature map obtained from a previous layer of a deep network based on the image data generated by one or more of these sensors. For example, the optical sensor may be an infrared sensor for infrared imaging. The optical sensor may also be a Charge Coupled Device (CCD) or Complementary Metal-Oxide Semiconductor (CMOS) image sensor for generating photos and videos. The radar sensors may include lidar, ultrasonic radar, millimeter wave radar, etc., for generating images about vehicles, pedestrians, and obstacles in a traffic environment. The ultrasonic sensors and nuclear magnetic resonance sensors may be used for medical imaging. The visual data in block 110 is collectively called as input feature map 110 hereinafter. The input feature map 110 may have a dimension of M×H×W, and may be denoted as F∈R^{M×H×W}, where M is the channel size of the input feature map, H and W respectively indicates the height and width of the input feature map. We denote f_{i,j}∈R^{M} as the feature tensors of pixel (i, j) corresponding to F, where i=0, 1, . . . H−1, and j=0, 1, . . . W−1.

Block 130 may be an output convolved feature map with a dimension of N×H×W, and may be denoted as G∈R^{N×H×W}, where N is the channel size of the convolved feature map, H and W respectively indicates the height and width of the convolved feature map. We denote g_{i,j}∈R^{N} as the feature tensors of pixel (i, j) corresponding to G, where i=0, 1, . . . H−1, and j=0, 1, . . . W−1.

Then, the standard convolution operation in block 120 may be formulated as:

$${g}_{i , j} = {\sum }_{p , q} {K}_{p , q} {f}_{i + p - ⌊ k / 2 ⌋ , j + q - ⌊ k / 2 ⌋} \qquad ( 1 )$$

where K_{p,q} ∈R^{N×M} represents kernel weights with regard to the indices of the kernel position (p, q) with p, q=0, 1, . . . k−1.

In one aspect of the disclosure, for simplicity we set the stride of convolution as 1. In case that the kernel size k is 1, the height and width of the convolved feature map 130 may be the same as the height and width of the input feature map 110. In case that the kernel size k is greater than 1, a convolution operation with padding may be performed, i.e., a number of zero or non-zero values may be padded around the input feature map, such that the height and width of the convolved feature map 130 may also be kept the same as the height and width of the input feature map 110, in order to avoid losing edge information of the visual data. For example, when k=3, one column of zeros may be padded respectively to the left and right of the input feature map, and one row of zeros may be padded respectively to the top and bottom of the input feature map. In this example, f_{-1,j}, f_{H,j}, f_{i,-1}, and f_{i,W} in equation (1) may equal to 0. Other alternative padding schemes may also be applied to the solutions in the present disclosure.

As shown in block 120, the standard convolution operation with a convolution kernel of k×k×M×N may be comprised of a number N of convolution operations with convolution kernels 120-1, 120-2 . . . 120-N of k×k×M, each corresponding to an output channel of the convolved feature map 130. Each convolution operation with a convolution kernel of k×k×M may generate a feature map of H×W with one channel by a linear addition of a number M of feature maps of H×W, each corresponding to an input channel of the input feature map 110 of M×H×W. Then, a number N of generated feature maps of H×W may be concatenated to generate the output convolved feature map 130 of N×H×W with a channel size of N.

In another aspect of the disclosure, in the case that the kernel size k is greater than 1, a standard convolution operation in equation (1) can be rewritten as a summation of the feature maps from different kernel positions denoted by (p, q):

$${g}_{ij} = {\sum }_{p , q} {g}_{ij}^{( p , q )} {g}_{ij} = {\sum }_{p , q} {g}_{ij}^{( p , q )} \qquad ( 2 )$$

$$where$$

$${g}_{ij}^{( p , q )} = {K}_{p , q} {f}_{i + p - ⌊ k / 2 ⌋ , j + q - ⌊ k / 2 ⌋} . \qquad ( 3 )$$

With variable substitutions, equation (3) is equivalent to:

$${g}_{i - p + ⌊ k / 2 ⌋ , j - q + ⌊ k / 2 ⌋}^{( p , q )} = {K}_{p , q} {f}_{ij} . \qquad ( 4 )$$

To further simplify the formulation, a Shift operation \tilde{f} [symbol] Shift (f, Δx, Δy) may be defined as:

$${\tilde{f}}_{i , j} = {f}_{i + Δ x , j + Δ y} , ∀ i , j \qquad ( 5 )$$

where Δx, Δy correspond to the horizontal and vertical displacements. As a result, the standard convolution can be decomposed as two stages:

$$Stage I : {t}_{ij}^{( p , q )} = {K}_{p , q} {f}_{ij} , \qquad ( 6 )$$

$$Stage II : {g}^{( p , q )} = Shift ( {t}^{( p , q )} , p - ⌊ k / 2 ⌋ , q - ⌊ k / 2 ⌋ ) , \qquad ( 7 )$$

$${g}_{ij} = {\sum }_{p , q} {g}_{ij}^{( p , q )} \qquad ( 8 )$$

In the first stage, the input feature map may be linearly projected with regard to the kernel weights from a certain position (p, q) of a convolution kernel of k×k×M×N for a standard k×k convolution operation, which is the same as a standard 1×1 convolution operation. In other words, each of the standard 1×1 convolution operation may be performed with a convolution kernel of 1×1×M×N corresponding to each kernel position (p, q) of the convolution kernel of k×k×M×N. Therefore, for a k×k convolution operation, a number k² of projected feature maps with a dimension of N×H×W may be generated in the first stage through a number k² of corresponding 1×1 convolution operations, based on the equation (3), (4) or (6). Then, in the second stage, the projected feature maps, which may also be called as intermediate feature maps, may be shifted according to the kernel positions based on the equation (5) and (7), and finally aggregated together based on the equation (8), thereby generating a convolved feature map as shown in block 130 of FIG. 1.

FIG. 2 illustrates an example of a two stage convolution operation in accordance with an aspect of the present disclosure. In this example, a standard 3×3 convolution operation with a convolution kernel 220 of 3×3×M×N may be decomposed into a two stage convolution operation as shown by block 230 and block 260 in FIG. 2.

In the first stage, as shown in block 230, the convolution kernel 220 may be split into 9 convolution kernels of 1×1×M×N respectively used for the 1×1 convolution operations in blocks 240-1, 240-2, . . . , 240-3. For example, a 1×1 convolution operation 240-1 with a kernel based on a position (0, 0) i.e. K_{0,0} may be performed on the input feature map 210 to generate an intermediate feature map 250-1 with tᵢⱼ^{(0,0)}=K_{0,0}fᵢⱼ; a 1×1 convolution operation 240-2 with a kernel based on a position (0, 1) i.e. K_{0,1} may be performed on the input feature map 210 to generate an intermediate feature map 250-2 with tᵢⱼ^{(0,1)}=K_{0,1}fᵢⱼ; . . . ; and a 1×1 convolution operation 240-9 with a kernel based on a position (2, 2) i.e. K_{2,2} may be performed on the input feature map 210 to generate an intermediate feature map 250-9 with tᵢⱼ^{(2,2)}=K_{2,2}fᵢⱼ, where fᵢⱼ corresponds to the pixel (i, j) of the input feature map 210.

In the second stage, the intermediate feature maps 250-1, 250-2, . . . , 250-9 may be shifted according to the kernel position (p, q). For example, according to equations (5) and (7), since k=3,

$$⌊ \frac{k}{2} ⌋ = 1 ,$$

with regard to the position (0, 0), g_{i,j}^{(0,0)}=Shift (tᵢⱼ^{(0,0)}, −1, −1)=t_{i-1,j-1}^{(0,0)}, that is the intermediate feature map 250-1 corresponding to the position (0, 0) may be shifted according to a shift operation S(−1, −1), as shown in block 260. Similarly, with regard to the position (0, 1), the intermediate feature map 250-2 may be shifted according to a shift operation S(−1, 0), such that g_{i,j}^{(0,1)}=t_{i-1,j}^{(0,1)}; with regard to the position (0, 2), the intermediate feature map may be shifted according to a shift operation S(−1, 1), such that g_{i,j}^{(0,2)}=t_{i-1,j+1}^{(0,2)}; with regard to the position (1, 0), the intermediate feature map may be shifted according to a shift operation S(0, −1), such that g_{i,j}^{(1,0)}=t_{i,j-1}^{(1,0)}; with regard to the position (1, 1), the intermediate feature map may be shifted according to a shift operation S(0, 0), such that g_{i,j}^{(1,1)}=t_{i,j}^{(1,1)}; with regard to the position (1, 2), the intermediate feature map may be shifted according to a shift operation S(0, 1), such that g_{i,j}^{(1,2)}=t_{i,j+1}^{(1,2)}; with regard to the position (2, 0), the intermediate feature map may be shifted according to a shift operation S(1, −1), such that g_{i,j}^{(2,0)}=t_{i+1,j-1}^{(2,0)}; with regard to the position (2, 1), the intermediate feature map may be shifted according to a shift operation S(1, 0), such that g_{i,j}^{(2,1)}=t_{i+1,j}^{(2,1)}; and with regard to the position (2, 2), the intermediate feature map 250-9 may be shifted according to a shift operation S(1, 1), such that g_{i,j}^{(2,2)}=t_{i+1,j+1}^{(2,2)}.

Then, as shown in block 260, the shifted intermediate feature map may be summed together to generate a convolved feature map 270 with the feature tensors of each pixel (i, j) denoted by gᵢⱼ. For example, with regard to the top left pixel (0, 0) in the output convolved feature map 270, based on equations (6)-(8), g_{0,0}=t_{-1,-1}^{(0,0)}+t_{-1,0}^{(0,1)}+t_{-1,1}^{(0,2)}+t_{0,-1}^{(1,0)}+t_{0,0}^{(1,1)}+t_{0,1}^{(1,2)}+t_{1,-1}^{(2,0)}+t_{1,0}^{(2,1)}+t_{1,1}^{(2,2)}=K_{0,0}f_{-1,-1}+K_{0,1}f_{-1,0}+K_{0,2}f_{-1,1}+K_{1,0}f_{0,-1}+K_{1,1}f_{0,0}+K_{1,2}f_{0,1}+K_{2,0}f_{1,-1}+K_{2,1}f_{1,0}+K_{2,2}f_{1,1}, which is the same as the result of a standard convolution operation with padding based on equation (1), as described above in connection with FIG. 1.

Generally, as shown in FIG. 2, a traditional convolution with kernel size k×k can be decomposed into k² individual 1×1 convolutions, followed by shift and summation operations. It can be seen that most of the computational costs are performed in the 1×1 convolutions, while the shift and summation operations are lightweight.

In another aspect, attention mechanism has also been widely adopted in vision tasks. Comparing to the traditional convolution, attention allows the model to focus on important regions within a larger size of context, while the advantage also comes with high computation and memory cost.

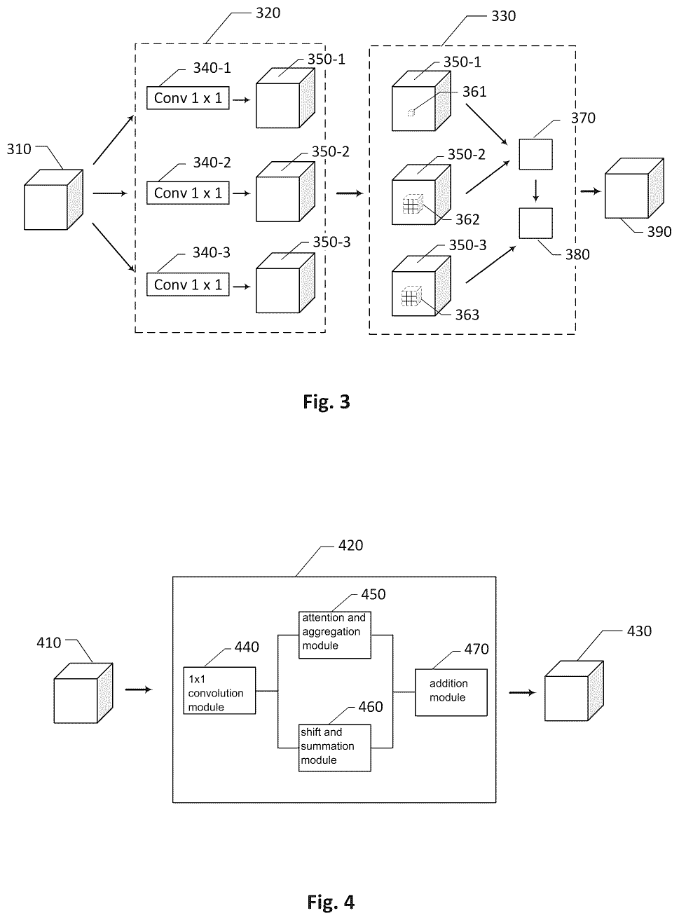

FIG. 3 illustrates an example of a two stage self-attention operation in accordance with an aspect of the present disclosure. In this example, a standard self-attention operation with L heads may be considered. Block 310 may be input visual data including image data obtained from various sensors, or a feature map obtained from a previous layer of a deep network based on the image data, which is generally called as input feature map 310 hereinafter. For example, the various sensors may comprise optical sensors, radar sensors, ultrasonic sensors, or nuclear magnetic resonance sensors. The input feature map 310 may have a dimension of M×H×W, and may be denoted as F∈R^{M×H×W}, where M is the channel size of the input feature map, H and W respectively indicates the height and width of the input feature map. We denote f_{i,j}∈R^{M} as the feature tensors of pixel (i, j) corresponding to F, where i=0, 1, . . . H−1, and j=0, 1, . . . W−1.

Block 390 may be an output attention weighted map with a dimension of N×H×W, and may be denoted as G∈R^{N×H×W}, where N is the channel size of the output attention weighted map, H and W respectively indicates the height and width of the attention weighted map. We denote g_{i,j}∈R^{N} as the feature tensors of pixel (i, j) corresponding to G, where i=0, 1, . . . H−1, and j=0, 1, . . . W−1.

Then, output of the standard self-attention operation may be formulated as:

$${g}_{ij} = {‖}_{l = 1}^{L} ( {\sum }_{a , b ∈ {𝒩}_{k} ( i , j )} A ( {W}_{q}^{( l )} {f}_{ij} , {W}_{k}^{( l )} {f}_{ab} ) {W}_{v}^{( l )} {f}_{ab} ) \qquad ( 9 )$$

where ∥ is the concatenation of the outputs of L attention heads, and W_{q}^{(l)}, Wₖ^{(l)}, Wᵥ^{(l)} are the projection matrices for queries, keys and values. [symbol] (i, j) represents a local region of pixels with spatial extent k centered around (i, j) as shown by blocks 362 and 363 in FIG. 3, and A(W_{q}^{(l)}fᵢⱼ, Wₖ^{(l)}f_{ab}) is the corresponding attention weight with regard to the features within [symbol] (i, j). In one embodiment, the attention weights may be computed as:

$$A ( {W}_{q}^{( l )} {f}_{ij} , {W}_{k}^{( l )} {f}_{ab} ) = {softmax}_{{𝒩}_{k} ( i , j )} ( {( {W}_{q}^{( l )} {f}_{ij} )}^{T} ( {W}_{k}^{( l )} {f}_{ab} ) / \sqrt{d} ) \qquad ( 10 )$$

where d is a feature dimension of W_{q}^{(l)}fᵢⱼ. In another embodiment, the attention weights are computed as:

$$A ( {W}_{q}^{( l )} {f}_{ij} , {W}_{k}^{( l )} {f}_{ab} ) = ϕ ( [ {W}_{q}^{( l )} {f}_{ij} , {[ {W}_{k}^{( l )} {f}_{ab} ]}_{a , b ∈ {𝒩}_{k} ( i , j )} ] ) \qquad ( 11 )$$

where ϕ(·) is a projection function.

As shown in FIG. 3, the standard self-attention operation can also be decomposed into two stages and reformulated as:

$$Stage I : {q}_{ij}^{( l )} = {W}_{q}^{( l )} {f}_{ij} , {k}_{ij}^{( l )} = {W}_{k}^{( l )} {f}_{ij} , {v}_{ij}^{( l )} = {W}_{v}^{( l )} {f}_{ij} \qquad ( 12 )$$

$$Stage II : {g}_{ij} = {‖}_{l = 1}^{L} ( {\sum }_{a , b ∈ {𝒩}_{k} ( i , j )} A ( {q}_{ij}^{( l )} , {k}_{ab}^{( l )} ) {v}_{ab}^{( l )} ) \qquad ( 13 )$$

Similar to the two stage convolution described above, in block 320, three 1×1 convolutions 340-1, 340-2 and 340-3 are first conducted in stage I with heavy computational cost, and generate three corresponding intermediate feature maps 350-1, 350-2, and 350-3 respectively used for queries, keys and values. We denote W_{q}, Wₖ, Wᵥ∈R^{M×N} as the convolution kernel used in each of the 1×1 convolutions, where M and N are the input and output channel size. In block 330 of stage II, the calculation of the attention weights may be conducted based on a query such as 361 and a key such as 362 in block 370 and aggregation of the value matrices may be conducted based on the calculated attention weights and a value such as 363 in block 380, where the costs depend on the receptive field k of each pixel.

As shown in FIGS. 2 and 3, the convolution module and the self-attention module can be decomposed into two stages, and they both have the same computation operation on the linear projection of the input feature map through 1×1 convolutions in the first stage. Therefore, the present disclosure provides a hybrid model which enjoys the benefits of both convolution and self-attention modules by elegantly integrating these two modules with minimum computational overhead. Generally, the hybrid model may first project input feature maps with 1×1 convolutions and obtain a rich set of intermediate feature maps. Then, these feature maps may be reused and aggregated following different paradigms, which may process the features in self-attention and convolution manners respectively. In this way, we can effectively avoid conducting expensive projection operations twice, and the two distinct paradigms with different purposes only contribute a small fraction of computation.

FIG. 4 illustrates a block diagram of an apparatus for computer vision processing in accordance with the hybrid model of the present disclosure. As shown in FIG. 4, the apparatus 420 may comprise a 1×1 convolution module 440, an attention and aggregation module 450, a shift and summation module 460, and an addition module 470.

The 1×1 convolution module 440 may be configured to project input visual data 410 into a plurality of intermediate feature maps by performing a plurality of 1×1 convolution operations in a first stage. In one embodiment, the 1×1 convolution module 440 may comprise three 1×1 convolution operation paths respectively corresponding queries, keys and values in consistent with traditional self-attention operations. The 1×1 convolution module 440 may also be configured to reshape an intermediate feature map output from each path into a number Nₕ of intermediate feature maps for a following multi-head self-attention operation, and Nₕ is the number of heads of the multi-head self-attention operation. For example, if the output channel size of an intermediate feature map generated from a 1×1 convolution operation path is N, the intermediated feature map may be reshaped into Nₕ intermediate feature map each have a channel size of N/Nₕ, where N is an integer multiple of Nₕ.

In a second stage, the attention and aggregation module 450 and the shift and summation module 460 may be configured to process the plurality of intermediate feature maps in parallel based on different purposes of self-attention and traditional convolution. Specifically, the attention and aggregation module 450 may be configured to generate an attention weighted map by performing attention and aggregation operations on the plurality of intermediate feature maps. If the attention and aggregation module 450 may receive three sets of intermediate feature maps from the 1×1 convolution module 440, each set of intermediate feature map being generated by a separate convolution path of the 1×1 convolution module 440, the attention and aggregation module 450 may directly use the three sets of intermediate feature maps as queries, keys and values. Otherwise, the attention and aggregation module 450 may be configured to generate three sets of intermediate feature maps based on the received plurality of intermediate feature maps e.g. through a fully connected layer. Each set of intermediate feature map may comprise one intermediate feature map for single-head self-attention operation, or more intermediate feature maps for multi-head self-attention operation. In another embodiment, the attention and aggregation module 450 may generate a number Nₕ of groups of intermediate feature maps based on the received plurality of intermediate feature maps e.g. through a fully connected layer, wherein Nₕ is a number of heads of the self-attention operation. Each group may include three intermediate feature maps respectively serving as query, key, and value for self-attention operation. For the Nₕ groups of intermediate feature maps, the attention and aggregation module 450 may generate Nₕ attention weighted maps by performing attention and aggregation operations respectively on each group of intermediate feature maps, and then concatenate the Nₕ attention weighted maps.

In the second stage, the shift and summation module 460 may be configured to generate a convolved feature map by performing shift and summation operations on the received plurality of intermediate feature maps. In one embodiment, for a convolution operation with kernel size k, the shift and summation module 460 may generate a number k² of intermediate feature maps as a linear combination of all of the intermediate feature maps through a light fully connected layer. In another embodiment, to additionally improve the expressiveness of the convolution path, the shift and summation module 460 may generate a number N_{c} of groups of intermediate feature maps based on the plurality of intermediate feature maps through multiple fully connected layers, each group including a number k² of intermediate feature maps, and N_{c} is an integer greater than 1. The shift and summation module 460 may generate N_{c} convolved feature maps by performing shift and summation operations respectively on each group of intermediate feature maps and concatenate the N_{c} convolved feature maps.

Then, the addition module 470 may be configured to add the attention weighted map and the convolved feature map based on at least one scalar. For example, the outputs from the attention and aggregation module 450 and the shift and summation module 460 may be added together and the strengths may be controlled by two learnable scalars as follows:

$${F}_{out} = α {F}_{attention} + β {F}_{convolution} \qquad ( 14 )$$

Due to the flexibility of the Nₕ and N_{c}, the output dimensions of the attention and aggregation module 450 and the shift and summation module 460 may be inconsistent. In some embodiments, a ratio of N_{c}/Nₕ may be set as ¼ or ⅛. Therefore, the addition module 470 may be configured to adjust a channel size of at least one of the attention weighted map and the convolved feature map to make the attention weighted map and the convolved feature map having the same channel size. In one embodiment, an additional 1×1 convolution layer may be adopted by the addition module 470 to adjust the channel size of the output of the shift and summation module 460.

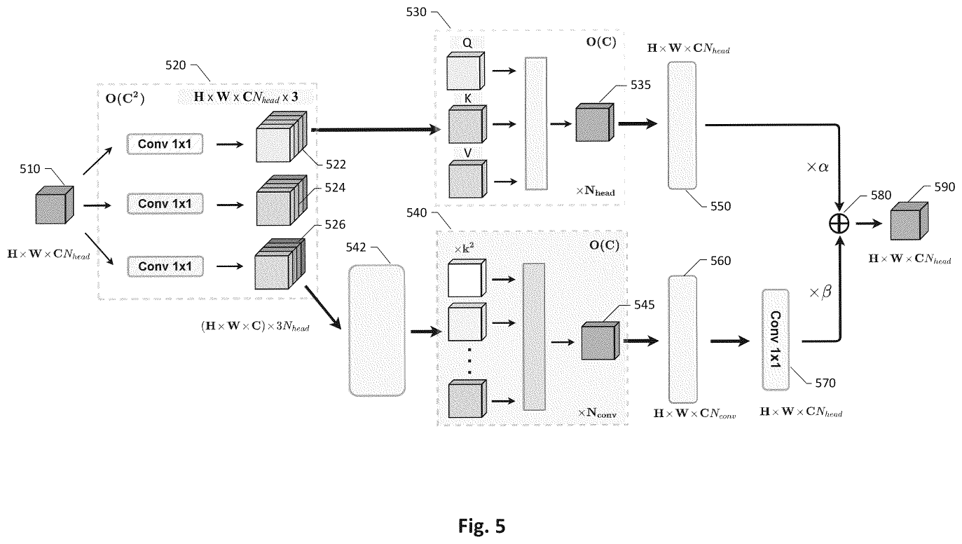

FIG. 5 illustrates an example of a hybrid model of self-attention and convolution in accordance with one aspect of the present disclosure. As shown by FIG. 5, a feature map with a dimension of H×W×C may be processed firstly into an input feature map 510 with a dimension of H×W×CN_{head} by repetition, in order to adapt to the following multi-head self-attention operation, wherein C is the original input channel size and N_{head} is the number of heads of the multi-head self-attention.

In block 520, the input feature map 510 may be projected by three 1×1 convolutions to generate three intermediate feature maps 522, 524, and 526 with a dimension of H×W×CN_{head}. In this example, the 1×1 convolution operation will not change the channel size, that is the output channel size of the 1×1 convolution operation is also CN_{head}, remaining the same as the input channel size. Then, each of the intermediate feature maps 522, 524, and 526 may be reshaped into N_{head} pieces, each piece being an intermediate feature map with a dimension of H×W×C. Thus, a rich set of intermediate feature maps containing 3×N_{head} feature maps may be obtained and reused following different learning paradigms in blocks 530 and 540 respectively.

In block 530 for a self-attention path, the plurality of intermediate feature maps may be gathered into N_{head} groups, each group containing three pieces of intermediate feature maps (Q, K, and V), one from each 1×1 convolution. The three intermediate feature maps may be serve as Query, Key, and Value, and may be processed following a standard self-attention operation to generate an attention weighted feature map 535 with a dimension of H×W×C. Thus, N_{head} attention weighted feature maps may be generated for the N_{head} groups of intermediate feature maps, and then these feature maps may be concatenated together in block 550 into an attention weighted feature map with a dimension of H×W×CN_{head}.

In block 542, one or multiple fully connected layers may be adopted to compose a number N_{conv} of groups of intermediate feature maps based on the 3×N_{head} feature maps from block 520. Each group may contain k² feature maps as a liner combination of all of the 3×N_{head} feature maps. In one embodiment, the block 542 may be located within block 540. In block 540, shift and summation operation as described above in connection with FIG. 2 may be performed on each group of k² intermediate feature maps to generate a convolved feature map 545 with a dimension of H×W×C. Thus, N_{conv} convolved feature maps may be generated for the N_{conv} groups of intermediate feature maps, and then these feature maps may be concatenated together in block 560 into a convolved feature map with a dimension of H×W×CN_{conv}.

In block 570, in case that N_{conv} is not equal to N_{head}, an additional 1×1 convolution layer may be adopted to adjust channel size of the convolved feature map generated in block 560 from CN_{conv} to CN_{head}, to be consistent with the channel size of the attention weighted feature map generated in block 550. Then, the attention weighted feature map and the convolved feature map can be added together under the control of two learnable scalars α and β to generate an output feature map 590 with a dimension of H×W×CN_{head}.

As shown in FIG. 5, the 1×1 convolutions for feature learning in block 520 may contribute a computational complexity of O(C²), while the approaches corresponding to the procedure of gathering local information in blocks 530 and 540 each has a computational complexity of O(C), wherein C is the input and output channel size. Therefore, by sharing the heavy computations in an integration of convolution and self-attention, the hybrid model can extract features in both convolution and self-attention manners, but has minimum increase in the computation and memory usage.

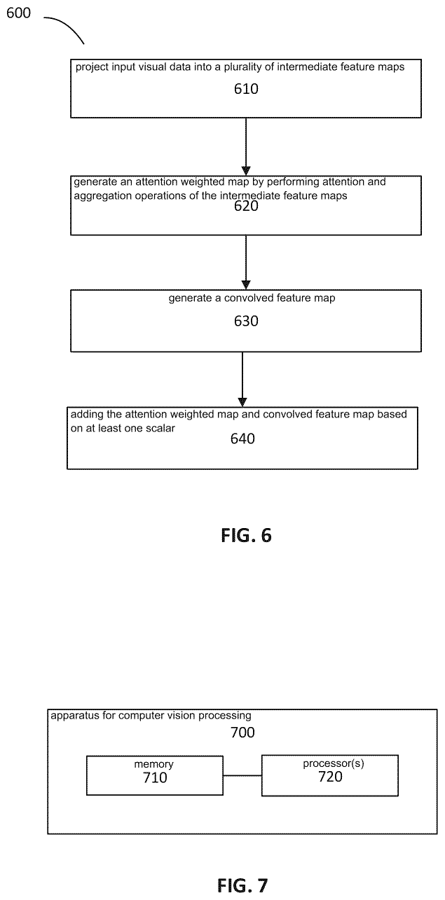

FIG. 6 illustrates a flow chart of a method 600 for computer vision processing in accordance with one aspect of the present disclosure. In block 610, the method 600 may comprise projecting input visual data into a plurality of intermediate feature maps by performing a plurality of 1×1 convolution operations. The input visual data may comprise image data obtained from at least one of a optical sensor, a radar sensor, an ultrasonic sensor, or a nuclear magnetic resonance sensor, and a feature map obtained from a previous layer of a deep network based on the image data. In one embodiment, the plurality of 1×1 convolution operations may comprise three 1×1 convolution operation paths, and an intermediate feature map output from each path may be reshaped into a number Nₕ of intermediate feature maps, Nₕ is a number of heads of a self-attention operation.

In block 620, the method 600 may comprise generating an attention weighted map by performing attention and aggregation operations on the plurality of intermediate feature maps. In one embodiment, the method 600 may generate a number Nₕ of groups of intermediate feature maps based on the plurality of intermediate feature maps, each group including three intermediate feature maps respectively serving as query, key, and value for self-attention operation, wherein Nₕ is a number of heads of the self-attention operation. The method 600 may generate Nₕ attention weighted maps by performing attention and aggregation operations respectively on each group of intermediate feature maps; and concatenate the Nₕ attention weighted maps together.

In block 630, the method 600 may comprise generating a convolved feature map by performing shift and summation operations on the plurality of intermediate feature maps. In one embodiment, the method 600 may generate a number N_{c} of groups of intermediate feature maps based on the plurality of intermediate feature maps, each group including a number k² of intermediate feature maps, wherein k is a size of a convolution kernel for a k×k convolution operation, and N_{c} is an integer greater than one. The method 600 may generate N_{c} convolved feature maps by performing shift and summation operations respectively on each group of intermediate feature maps; and concatenate the N_{c} convolved feature maps together.

In block 640, the method 600 may comprise adding the attention weighted map and the convolved feature map based on at least one scalar. In one embodiment, the strengths of the attention weighted map and the convolved feature map may be controlled by two learnable scalars. In another embodiment, due to the flexibility of the Nₕ and N_{c}, the method 600 may adjust a channel size of at least one of the attention weighted map and the convolved feature map to make the attention weighted map and the convolved feature map having the same channel size, such as through an additional 1×1 convolution layer.

FIG. 7 illustrates a block diagram of an apparatus 700 for computer vision processing in accordance with one aspect of the present disclosure. The apparatus 700 for computer vision processing may comprise a memory 710 and at least one processor 720. The processor 720 may be coupled to the memory 710 and configured to perform the method 600 described above with reference to FIG. 6. The processor 720 may be a general-purpose processor, or may also be implemented as a combination of computing devices, e.g., a combination of a DSP and a microprocessor, multiple microprocessors, one or more microprocessors in conjunction with a DSP core, or any other such configuration. The memory 710 may store the input data, output data, data generated by processor 720, and/or instructions executed by processor 720.

The various operations, modules, and networks described in connection with the disclosure herein may be implemented in hardware, software executed by a processor, firmware, or any combination thereof. According an embodiment of the disclosure, a computer program product for computer vision processing may comprise processor executable computer code for performing the method 600 described above with reference to FIG. 6. According to another embodiment of the disclosure, a computer readable medium may store computer code for computer vision processing, the computer code when executed by a processor may cause the processor to perform the method 600 described above with reference to FIG. 6. Computer-readable media includes both non-transitory computer storage media and communication media including any medium that facilitates transfer of a computer program from one place to another. Any connection may be properly termed as a computer-readable medium. Other embodiments and implementations are within the scope of the disclosure.

The preceding description of the disclosed embodiments of the present invention is provided to enable any person skilled in the art to make or use the various embodiments. Various modifications to these embodiments will be readily apparent to those skilled in the art, and the generic principles defined herein may be applied to other embodiments without departing from the scope of the various embodiments. Thus, the present invention is not intended to be limited to the embodiments shown herein but is to be accorded the widest scope consistent with the principles and novel features disclosed herein.

1-15. (canceled)

16. A method for computer vision processing, comprising the following steps:
projecting input visual data into a plurality of intermediate feature maps by performing a plurality of 1×1 convolution operations;
generating an attention weighted map by performing attention and aggregation operations on the plurality of intermediate feature maps;
generating a convolved feature map by performing shift and summation operations on the plurality of intermediate feature maps; and
adding the attention weighted map and the convolved feature map based on at least one scalar.

17. The method of claim 16, wherein the input visual data include: (i) image data obtained from at least one of a optical sensor, a radar sensor, an ultrasonic sensor, and a nuclear magnetic resonance sensor, or (ii) a feature map obtained from a previous layer of a deep network based on the image data.

18. The method of claim 16, wherein the plurality of 1×1 convolution operations includes three 1×1 convolution operation paths, and an intermediate feature map output from each path is reshaped into a number Nₕ of intermediate feature maps, Nₕ is a number of heads of a self-attention operation.

19. The method of claim 16, wherein the generating of the attention weighted map includes:
generating a number Nₕ of groups of intermediate feature maps based on the plurality of intermediate feature maps, each group including three intermediate feature maps respectively serving as query, key, and value for self-attention operation, wherein Nₕ is a number of heads of the self-attention operation;
generating Nₕ attention weighted maps by performing attention and aggregation operations respectively on each group of intermediate feature maps; and
concatenating the Nₕ attention weighted maps.

20. The method of claim 16, wherein the generating of the convolved feature map includes:
generating a number N_{c} of groups of intermediate feature maps based on the plurality of intermediate feature maps, each group including a number k² of intermediate feature maps, wherein k is a size of a convolution kernel for a k×k convolution operation, and N_{c} is an integer greater than one;
generating N_{c} convolved feature maps by performing shift and summation operations respectively on each group of intermediate feature maps; and
concatenating the N_{c} convolved feature maps.

21. The method of claim 16, wherein the adding of the attention weighted map and the convolved feature map includes:
adjusting a channel size of at least one of the attention weighted map and the convolved feature map to make the attention weighted map and the convolved feature map have the same channel size.

22. An apparatus for computer vision processing, comprising:
a 1×1 convolution module configured to project input visual data into a plurality of intermediate feature maps by performing a plurality of 1×1 convolution operations;
an attention and aggregation module configured to generate an attention weighted map by performing attention and aggregation operations on the plurality of intermediate feature maps;
a shift and summation module configured to generate a convolved feature map by performing shift and summation operations on the plurality of intermediate feature maps; and
an addition module, configured to add the attention weighted map and the convolved feature map based on at least one scalar.

23. The apparatus of claim 22, wherein the input visual data include: (i) data obtained from at least one of a optical sensor, a radar sensor, an ultrasonic sensor, and a nuclear magnetic resonance sensor, or (ii) a feature map obtained from a previous layer of a deep network based on the image data.

24. The apparatus of claim 22, wherein the 1×1 convolution module includes three 1×1 convolution operation paths, and is further configured to reshape an intermediate feature map output from each path into a number Nₕ of intermediate feature maps, Nₕ is a number of heads of a self-attention operation.

25. The apparatus of claim 22, wherein the attention and aggregation module is configured to:
generate a number Nₕ of groups of intermediate feature maps based on the plurality of intermediate feature maps through a fully connected layer, each group including three intermediate feature maps respectively serving as query, key, and value for self-attention operation, wherein Nₕ is a number of heads of the self-attention operation;
generate Nₕ attention weighted maps by performing attention and aggregation operations respectively on each group of intermediate feature maps; and
concatenate the Nₕ attention weighted maps.

26. The apparatus of claim 22, wherein the shift and summation module is configured to:
generate a number N_{c} of groups of intermediate feature maps based on the plurality of intermediate feature maps through multiple fully connected layers, each group including a number k² of intermediate feature maps, wherein k is a size of a convolution kernel for a k×k convolution operation, and N_{c} is an integer greater than one;
generate N_{c} convolved feature maps by performing shift and summation operations respectively on each group of intermediate feature maps; and
concatenate the N_{c} convolved feature maps.

27. The apparatus of claim 22, wherein the addition module is configured to:
adjust a channel size of at least one of the attention weighted map and the convolved feature map to make the attention weighted map and the convolved feature map having the same channel size.

28. An apparatus for computer vision processing, comprising:
a memory; and
at least one processor coupled to the memory and configured to perform computer vision processing, the processor configured to:
project input visual data into a plurality of intermediate feature maps by performing a plurality of 1×1 convolution operations;
generate an attention weighted map by performing attention and aggregation operations on the plurality of intermediate feature maps;
generate a convolved feature map by performing shift and summation operations on the plurality of intermediate feature maps; and
add the attention weighted map and the convolved feature map based on at least one scalar.

29. A non-transitory computer readable medium on which is stored computer code for computer vision processing, the computer code, when executed by a processor, causing the processor to perform the following steps:
project input visual data into a plurality of intermediate feature maps by performing a plurality of 1×1 convolution operations;
generate an attention weighted map by performing attention and aggregation operations on the plurality of intermediate feature maps;
generate a convolved feature map by performing shift and summation operations on the plurality of intermediate feature maps; and
add the attention weighted map and the convolved feature map based on at least one scalar.
